(19) United States
(12) Patent Application Publication
(10) Pub. No.: US 2024/0275449 A1
(43) Pub. Date: Aug. 15, 2024

(54) METHOD AND APPARATUS FOR NETWORK ENERGY SAVING BY TURNING OFF TRANSMIT CHAINS

(71) Applicants: RAKUTEN MOBILE USA LLC, San Mateo, CA (US); RAKUTEN MOBILE, INC., Tokyo (JP)

(72) Inventors: Erdem BALA, San Mateo, CA (US); Antonio FORENZA, San Mateo, CA (US); Awn MUHAMMAD, Tokyo (JP)

(73) Assignees: RAKUTEN MOBILE USA LLC, San Mateo, CA (US); RAKUTEN MOBILE, INC., Tokyo (JP)

(21) Appl. No.: 18/005,516

(22) PCT Filed: Nov. 23, 2022
(86) PCT No.: PCT/US2022/050847

§ 371 Date: Jan. 13, 2023

Related U.S. Application Data
(60) Provisional application No. 63/396,457, filed on Aug. 9, 2022.

(51) Int. Cl. H04B 7/06; H04W 52/02; H04W 72/23

(52) U.S. Cl. CPC H04B 7/0626; H04W 52/0225; H04W 72/23

(57) ABSTRACT

A method includes sending a first set of one or more probing messages to a UE, the first set of the one or more probing messages including a set of reference signals. The method includes receiving, in response to the first one or more probing messages, a first channel state information (CSI) report from the UEs that includes first CSI derived from measurements of the set of reference signals. The method includes sending, a second set of one or more probing messages to the UE, the second set of the one or more probing messages including a subset of the reference signals. The method further includes receiving, in response to the second set of one or more probing messages, a second CSI report that includes second CSI derived from measurement of the subset of the reference signals.

### CROSS-REFERENCE TO RELATED APPLICATION

This application is based on and claims priority to U.S. Patent Application No. 63/396,457, filed on Aug. 9, 2022, the disclosure of which is incorporated by reference herein in its entirety.

### TECHNICAL FIELD

The present disclosure relates generally to communication systems, and more particularly to methods and apparatuses for network energy saving by turning off transmit chains.

### BACKGROUND

In a conventional multiple-input and multiple-output (MIMO) system, a plurality of ports (e.g., channel state information reference signal (CSI-RS) ports) or data streams may be mapped to a plurality of transmission radio distribution units (TXRUs). This operation may be referred to as port virtualization and may be considered as digital precoding. The outputs of the TXRUs may then be mapped in the analog domain to the antenna units via TXRU virtualization. The output of a TXRU may be mapped to a group of co-polarized antenna elements through analog phase shifters or variable gain amplifiers. The terms transmit chain and TXRU may be used interchangeably. A TXRU may comprise a power amplifier, filters, a digital/analog converter, etc. Since these components consume most of the power in a gNB, turning off TXRUs may be used to save energy in the network.

Turning off transmit antenna chains or antenna elements may be performed by the gNB or a network implementation, where turning off transmit chains causes a reduction in transmitted energy from the base station. However, either the energy saving is limited or the impact on UE performance is significant since turning off transmit chains is performed without UE coordination. Particularly, the lack of UE coordination fails to ensure that those UEs that would be most impacted due to the received power loss can maintain acceptable communication performance. In addition, the failure to turn on/off base station components in a dynamic manner results in non-optimal energy saving vs. performance loss.

Improvements are presented herein. These improvements may also be applicable to other multi-access technologies and the telecommunication standards that employ these technologies.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Methods, apparatuses, and non-transitory computer-readable mediums for network energy saving by turning off transmit chains are disclosed by the present disclosure.

According to an exemplary embodiment, a method performed by at least one processor of a base station includes sending, in a first state, a first set of one or more probing messages to a UE, the first set of the one or more probing messages including a set of reference signals. The method further includes receiving, in response to the first one or more probing messages, a first channel state information (CSI) report from the UEs that includes first CSI derived from measurements of the set of reference signals. The method further includes sending, in a second state, a second set of one or more probing messages to the UE, the second set of the one or more probing messages including a subset of the reference signals. The method further includes receiving, in response to the second set of one or more probing messages, a second CSI report that includes second CSI derived from measurement of the subset of the reference signals.

According to an exemplary embodiment, an apparatus includes at least one memory configured to store computer program code and at least one processor configured to access said at least one memory and operate as instructed by the computer program code. The computer program code includes first sending code configured to cause at least one of said at least one processor to send, in a first state, a first set of one or more probing messages to a UE, the first set of the one or more probing messages including a set of reference signals. The computer program code includes first receiving code configured to cause at least one of said at least one processor to receive, in response to the first one or more probing messages, a first channel state information (CSI) report from the UEs that includes first CSI derived from measurements of the set of reference signals. The computer program code includes second sending code configured to cause at least one of said at least one processor to send, in a second state, a second set of one or more probing messages to the UE, the second set of the one or more probing messages including a subset of the reference signals. The computer program code includes second receiving, in response to the second set of one or more probing messages, a second CSI report that includes second CSI derived from measurement of the subset of the reference signals.

According to an exemplary embodiment, a non-transitory computer readable medium having instructions stored therein, which when executed by a processor in a base station cause the processor to execute a method that includes sending, in a first state, a first set of one or more probing messages to a UE, the first set of the one or more probing messages including a set of reference signals. The method further includes receiving, in response to the first one or more probing messages, a first channel state information (CSI) report from the UEs that includes first CSI derived from measurements of the set of reference signals. The method further includes sending, in a second state, a second set of one or more probing messages to the UE, the second set of the one or more probing messages including a subset of the reference signals. The method further includes receiving, in response to the second set of one or more probing messages, a second CSI report that includes second CSI derived from measurement of the subset of the reference signals.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other aspects, features, and aspects of embodiments of the disclosure will be apparent from the following description taken in conjunction with the accompanying drawings, in which:

FIG. 1 is a diagram of an example network device in accordance with various embodiments of the present disclosure.

FIG. 2 is a schematic diagram of an example wireless communications system, in accordance with various embodiments of the present disclosure.

FIG. 3 is an example time sequence diagram illustrating a normal state and a time skipping window, in accordance with various embodiments of the present disclosure.

FIG. 4 is an example time sequence diagram illustrating a time skipping window, in accordance with various embodiments of the present disclosure.

FIG. 5 is an example time sequence diagram illustrating aperiodic activation of the energy saving state, in accordance with various embodiments of the present disclosure.

FIG. 6 is an example flow chart of an embodiment of a process for performing network energy saving by turning off transmit chains.

FIG. 7 is an example flow chart of an embodiment of a process for probing UEs.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Embodiments of the present disclosure are directed to performing network energy saving by turning off transmit chains. In some embodiments, a gNB may be able to enter one of various energy saving states at a given time (e.g., normal state and energy saving state in which a plurality of the transmit chains are turned off) and indicate dynamically the current and future states to the UEs. In some embodiments, a gNB may collect feedback from the UEs and classify the UEs based on the feedback into one of at least two groups: (1) UEs that can maintain acceptable performance when some transmit chains are turned off, (2) UEs that cannot maintain acceptable performance when some transmit chains are turned off. The UEs in the second group may be configured with coverage enhancement techniques. The gNB may dynamically turn on/off a plurality of transmit chains. When the gNB is in an energy saving state, the UEs in the second group may suspend certain communication activities.

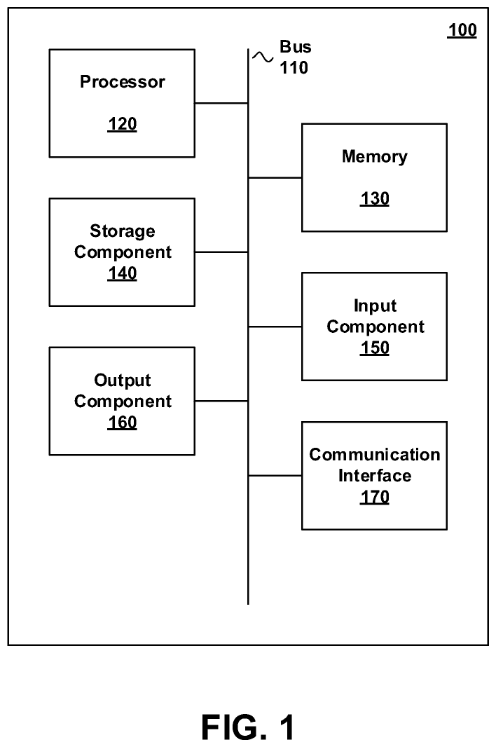

FIG. 1 is diagram of an example device for performing embodiments of the present disclosure. Device 100 may correspond to any type of known computer, server, or data processing device. For example, the device 100 may comprise a processor, a personal computer (PC), a printed circuit board (PCB) comprising a computing device, a mini-computer, a mainframe computer, a microcomputer, a telephonic computing device, a wired/wireless computing device (e.g., a smartphone, a personal digital assistant (PDA)), a laptop, a tablet, a smart device, or any other similar functioning device.

In some embodiments, as shown in FIG. 1, the device 100 may include a set of components, such as a processor 120, a memory 130, a storage component 140, an input component 150, an output component 160, and a communication interface 170.

The bus 110 may comprise one or more components that permit communication among the set of components of the device 100. For example, the bus 110 may be a communication bus, a cross-over bar, a network, or the like. Although the bus 110 is depicted as a single line in FIG. 1, the bus 110 may be implemented using multiple (two or more) connections between the set of components of device 100. The disclosure is not limited in this regard.

The device 100 may comprise one or more processors, such as the processor 120. The processor 120 may be implemented in hardware, firmware, and/or a combination of hardware and software. For example, the processor 120 may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general-purpose single-chip or multi-chip processor, or other programmable logic device, discrete gate or transistor logic, discrete hardware components, or any combination thereof designed to perform the functions described herein. A general-purpose processor may be a microprocessor, or any conventional processor, controller, microcontroller, or state machine. The processor 120 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The processor 120 may control overall operation of the device 100 and/or of the set of components of device 100 (e.g., the memory 130, the storage component 140, the input component 150, the output component 160, the communication interface 170).

The device 100 may further comprise the memory 130. In some embodiments, the memory 130 may comprise a random-access memory (RAM), a read only memory (ROM), an electrically erasable programmable ROM (EEPROM), a flash memory, a magnetic memory, an optical memory, and/or another type of dynamic or static storage device. The memory 130 may store information and/or instructions for use (e.g., execution) by the processor 120.

The storage component 140 of device 100 may store information and/or computer-readable instructions and/or code related to the operation and use of the device 100. For example, the storage component 140 may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

The device 100 may further comprise the input component 150. The input component 150 may include one or more components that permit the device 100 to receive information, such as via user input (e.g., a touch screen, a keyboard, a keypad, a mouse, a stylus, a button, a switch, a microphone, a camera, and the like). Alternatively, or additionally, the input component 150 may include a sensor for sensing information (e.g., a global positioning system (GPS) component, an accelerometer, a gyroscope, an actuator, and the like).

The output component 160 of device 100 may include one or more components that may provide output information from the device 100 (e.g., a display, a liquid crystal display (LCD), light-emitting diodes (LEDs), organic light emitting diodes (OLEDs), a haptic feedback device, a speaker, and the like).

The device 100 may further comprise the communication interface 170. The communication interface 170 may include a receiver component, a transmitter component, and/or a transceiver component. The communication interface 170 may enable the device 100 to establish connections and/or transfer communications with other devices (e.g., a server, another device). The communications may be affected via a wired connection, a wireless connection, or a combination of wired and wireless connections. The communication interface 170 may permit the device 100 to receive information from another device and/or provide information to another device. In some embodiments, the communication interface 170 may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively, or additionally, the communication interface 170 may provide for communications with another device via a device-to-device (D2D) communication link, such as FlashLinQ, WiMedia, Bluetooth, ZigBee, Wi-Fi, LTE, 5G, and the like. In other embodiments, the communication interface 170 may include an Ethernet interface, an optical interface, a coaxial interface, an infrared interface, a radio frequency (RF) interface, or the like.

The device 100 may perform one or more processes described herein. The device 100 may perform operations based on the processor 120 executing computer-readable instructions and/or code that may be stored by a non-transitory computer-readable medium, such as the memory 130 and/or the storage component 140. A computer-readable medium may refer to a non-transitory memory device. A memory device may include memory space within a single physical storage device and/or memory space spread across multiple physical storage devices.

Computer-readable instructions and/or code may be read into the memory 130 and/or the storage component 140 from another computer-readable medium or from another device via the communication interface 170. The computer-readable instructions and/or code stored in the memory 130 and/or storage component 140, if or when executed by the processor 120, may cause the device 100 to perform one or more processes described herein.

Alternatively, or additionally, hardwired circuitry may be used in place of or in combination with software instructions to perform one or more processes described herein. Thus, embodiments described herein are not limited to any specific combination of hardware circuitry and software.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of (one or more) components shown in FIG. 1 may perform one or more functions described as being performed by another set of components shown in FIG. 1.

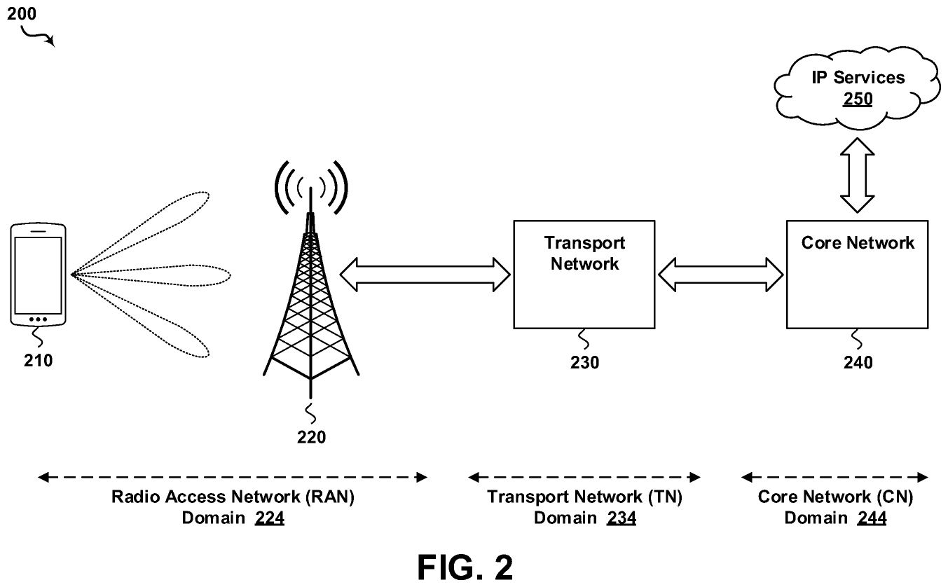

FIG. 2 is a diagram illustrating an example of a wireless communications system, according to various embodiments of the present disclosure. The wireless communications system 200 (which may also be referred to as a wireless wide area network (WWAN)) may include one or more user equipment (UE) 210, one or more base stations 220, at least one transport network 230, and at least one core network 240. The device 100 (FIG. 1) may be incorporated in the UE 210 or the base station 220.

The one or more UEs 210 may access the at least one core network 240 and/or IP services 250 via a connection to the one or more base stations 220 over a RAN domain 224 and through the at least one transport network 230. Examples of UEs 210 may include a cellular phone, a smart phone, a session initiation protocol (SIP) phone, a laptop, a personal digital assistant (PDA), a satellite radio, a global positioning system (GPS), a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similarly functioning device. Some of the one or more UEs 210 may be referred to as Internet-of-Things (IoT) devices (e.g., parking meter, gas pump, toaster, vehicles, heart monitor, etc.). The one or more UEs 210 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile agent, a client, or some other suitable terminology.

The one or more base stations 220 may wirelessly communicate with the one or more UEs 210 over the RAN domain 224. Each base station of the one or more base stations 220 may provide communication coverage to one or more UEs 210 located within a geographic coverage area of that base station 220. In some embodiments, as shown in FIG. 2, the base station 220 may transmit one or more beamformed signals to the one or more UEs 210 in one or more transmit directions. The one or more UEs 210 may receive the beamformed signals from the base station 220 in one or more receive directions. Alternatively, or additionally, the one or more UEs 210 may transmit beamformed signals to the base station 220 in one or more transmit directions. The base station 220 may receive the beamformed signals from the one or more UEs 210 in one or more receive directions.

The one or more base stations 220 may include macrocells (e.g., high power cellular base stations) and/or small cells (e.g., low power cellular base stations). The small cells may include femtocells, picocells, and microcells. A base station 220, whether a macrocell or a large cell, may include and/or be referred to as an access point (AP), an evolved (or evolved universal terrestrial radio access network (E-UTRAN)) Node B (eNB), a next-generation Node B (gNB), or any other type of base station known to one of ordinary skill in the art.

The one or more base stations 220 may be configured to interface (e.g., establish connections, transfer data, and the like) with the at least one core network 240 through at least one transport network 230. In addition to other functions, the one or more base stations 220 may perform one or more of the following functions: transfer of data received from the one or more UEs 210 (e.g., uplink data) to the at least one core network 240 via the at least one transport network 230, transfer of data received from the at least one core network 240 (e.g., downlink data) via the at least one transport network 230 to the one or more UEs 210.

The transport network 230 may transfer data (e.g., uplink data, downlink data) and/or signaling between the RAN domain 224 and the CN domain 244. For example, the transport network 230 may provide one or more backhaul links between the one or more base stations 220 and the at least one core network 240. The backhaul links may be wired or wireless.

The core network 240 may be configured to provide one or more services (e.g., enhanced mobile broadband (eMBB), ultra-reliable low-latency communications (URLLC), and massive machine type communications (mMTC), etc.) to the one or more UEs 210 connected to the RAN domain 224 via the TN domain 234. Alternatively, or additionally, the core network 240 may serve as an entry point for the IP services 250. The IP services 250 may include the Internet, an intranet, an IP multimedia subsystem (IMS), a streaming service (e.g., video, audio, gaming, etc.), and/or other IP services.

In some embodiments, the gNB (e.g., 220) may deactivate (e.g., turn off, not use) a subset of the transceiver chains, for example, to save energy. Depending on the port-to-TXRU mapping, this deactivation may result in one or a plurality of the ports (e.g., CSI-RS ports) to be deactivated. Deactivated resources may not be available to the UEs. The state when TXRUs are turned off may be referred to as the energy saving state. The state when TXRUs are not turned off may be referred to as the normal state.

TXRUs may not be visible to the UEs (e.g., UEs may not know the exact number of TXRUs the gNB employs). However, deactivating a plurality of TXRUs may cause a plurality of ports to be unavailable to the UE. In some embodiments, the gNB may configure the UEs with at least two separate configurations. The first configuration may contain a first set of ports (e.g., CSI-RS ports), and the second configuration may contain a second set of ports. The second set may contain a smaller number of antenna ports than the first set. The second configuration may be used when TXRU chains are deactivated. For example, when there is one-to-one mapping between CSI-RS ports and TXRUs, with K (e.g., K=32) TXRUs, K CSI-RS ports may be supported. If, for example, K/2 of the TXRUs are deactivated, then K/2 CSI-RS ports may be supported. In another example, when TXRUs are deactivated, the number of supported ports may not change, but the total transmit power and/or beam width may still reduce to the lower number of active TXRUs. The received signal energy may also reduce.

The embodiments of the present disclosure are disclosed assuming the gNB and/or the network may be in two states (normal state and energy saving state). However, the embodiments may be extended to more than two states. For example, there may be a plurality of energy saving states depending on how much energy may be saved in each state. As an example, with K TXRUs, two separate energy saving states may correspond to when K/4 and K/2 TXRUs are turned off. Although the energy saving states may be achieved due to turning off a plurality of TXRUs, the same embodiments may be applicable if the energy saving states are enabled by other mechanisms (e.g., turning off antenna elements, etc.).

In some embodiments, the energy saving procedure may include probing UEs, UE classification, UE configuration, energy saving state indication, and energy saving application. In probing UEs, a gNB may indicate to the UEs to feedback channel state information (CSI) derived for normal and/or energy saving states. The UEs may also be indicated to report quantities other than CSI. The condition the gNB is in while probing UEs may be referred to as the probing phase. In UE classification, based on the UE feedback, UEs may be classified into separate groups. For example, based on their communication capability with reduced number of TXRUs. As an example, UEs that may need enhancements (e.g., coverage enhancement) in case a number of TXRUs are turned off may be classified in a first group. UEs that may continue operating without enhancements may be classified in a second group.

In UE configuration, the gNB may configure the UEs in the first group with coverage enhancement or other enhancement techniques. These techniques may be used when the gNB is in the energy saving state. For example, these UEs may be configured to monitor the physical downlink control channel (PDCCH) only when the gNB is in the normal state, and not monitor the PDCCH when gNB is in energy saving state. In another example, these UEs may be configured to apply specified coverage enhancement techniques when the gNB is in the energy saving state. During energy saving state indication, the gNB may adapt the energy saving state behavior over time. For example, the gNB may be in a normal state in some slots (e.g., all TXRUs are on), and the gNB may be in the energy saving state in some slots (e.g., a number of TXRUs are turned off). The gNB state progression over time may be referred to as an energy saving pattern, where the current and/or future state of the gNB may be indicated to the UEs based on the energy saving pattern. After the energy state is indicated, the gNB may apply energy saving (e.g., turns off TXRUs based on the indicated energy saving pattern). The condition the gNB is in while applying energy saving may be referred to as the energy saving phase. The probing phase and the energy saving phase may partially or fully overlap in time.

In some embodiments, the gNB may transmit reference signals and/or other signals that may be used by the UE to measure and derive the CSI (e.g., CSI-RS, synchronization signal blocks (SSBs)). The UE may derive at least two types of CSI (type 1 and type 2). Type 1 may correspond to reference signals transmitted by the gNB when the gNB is in the normal state. Type 2 may correspond to reference signals transmitted by the gNB when the gNB is in the energy saving state. For example, the gNB may have 32 TXRUs and 32 CSI-RS ports. The first type of CSI may be derived by the UE using this configuration. In a specific interval, the gNB may turn off 16 of the TXRUs and transmit reference signals using the remaining active TXRUs. In this specific interval, the number of CSI-RS ports may be set to 16. The second type of CSI may be derived using this configuration.

In some embodiments, a UE may be configured with two CSI reporting configurations. The parameters (e.g., number of CSI-RS ports, number of CSI-RS resources, etc.) in one configuration may correspond to the normal state, and the other configuration parameters may correspond to the energy saving state. The CSI configuration types may be periodic, aperiodic, and semi-static.

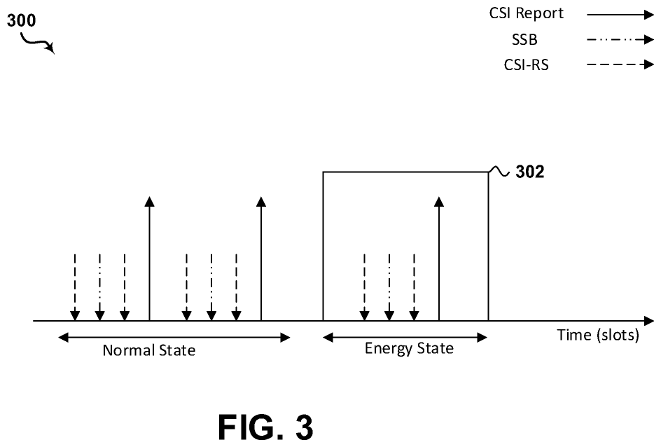

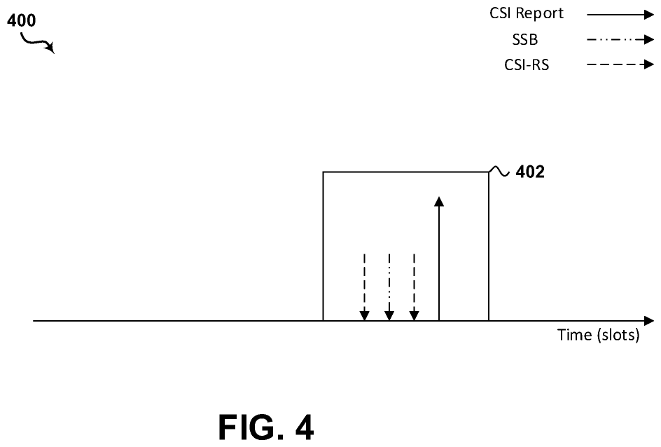

When the base station is not in an energy saving state (e.g., normal state), the UE may be configured to measure and report conventional CSI. For example, in the normal state, the base station may transmit 64 antennas. In some embodiments, the UE may be indicated to skip CSI-RS measurements in a specific time window. In that time window, the UE may be indicated to measure the CSI-RS and report CSI corresponding to the energy saving state. For example, for a given interval/window, the gNB indicates to the UE that 8 antennas instead of 64 are used. This window may be referred to as a time skipping window. An example time sequence 300 with a time skipping window 302 is illustrated in FIG. 3. During the time skipping window, the base station may be in the energy saving state, and UE does not use the original configuration of 64 antennas. As such, the UE skips measuring the 64 CSI-RS and reporting the corresponding CSI. Instead, during the time skipping window/interval, the UE may measure only 8 antennas and report the CSI for the 8 antennas. As illustrated in the time sequence 400 with time window 402 (FIG. 4), the UE may measure another set of CSI-RS associated to the energy saving state and report the associated CSI. The CSI reporting may be performed outside the window and DL transmission may be inside the window only.

In some embodiments, the skipping window may be configured by the gNB. The window may be periodic and may be configured with a periodicity for the starting point (or ending point) of the window, an offset value to shift the starting point (or ending point) and a length in time (e.g., in slots or ms). In another method, every kth CSI report of the configuration may be configured to be associated to the energy saving state. The reference signals to be used to derive every kth CSI report may be indicated to the UE. For example, the last CSI-RS and/or the last SSB before the k^{th} CSI report occasion may be assumed to be transmitted with a number of TXRUs turned off. In another example, a window may be defined with respect to the k^{th} CSI report occasion, and the reference signals within this window may be assumed to be transmitted with TXRUs turned off.

In another example, the UE may be configured with a CSI reporting configuration corresponding to the normal state. The value of certain parameters in the configuration may be updated temporarily. For example, the number of CSI-RS ports may be 32 in the normal state. During the time window 302 shown in FIG. 3, the number of ports may be set to 16 temporarily. Similarly, to derive the k^{th} CSI report, the number of ports may be set to 16.

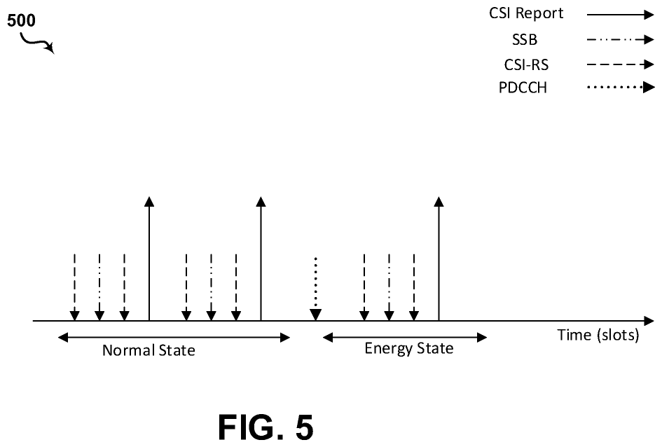

In some embodiments, the CSI reporting for the energy saving state may be activated with an aperiodic indication, as shown in FIG. 5, which illustrates example time sequence 500. The UE may be configured with a type 2 CSI configuration, where this configuration may be activated with the PDCCH. The activated type 2 CSI configuration may deactivate after a validity time period finishes. The activation of a type 2 CSI reporting configuration may deactivate the type 1 CSI reporting configuration, which means that the UE may skip (e.g., suspend) type 1 CSI reporting configuration until the validity time finishes.

In some embodiments, the PDCCH may set/reset the value of certain parameters of a CSI configuration. In this regard, after the validity time period finishes, the values of these parameters may be set top the values before the PDCCH indication. For example, a MAC CE may indicate to the UE the CSI-RS parameters shown in Table 1. Bits and/or codepoints in the PDCCH may set the number of CSI-RS ports in the configuration to one of the values in the table by indicating the row index. Values for other parameters may be added as columns to the table.

TABLE 1

| Index | CSI-RS Ports |
|---|---|
| 0 | 32 |
| 1 | 24 |
| 2 | 16 |
| 3 | 8 |

The probing phase and the energy saving phase may overlap partially or fully and the embodiments disclosed above may be used in the energy saving phase.

During the probing phase (e.g., when a number of TXRUs are turned off), certain UE procedures may be skipped and/or suspended. For example, one or more of the following may be applicable:
UE does not monitor PDCCH;
UE suspends assessing radio link quality;
UE suspends sending an indication to higher layers (e.g., the MAC layer) an indication that radio link quality is worse than the threshold;
UE suspends sending physical random access channel (PRACH);
UE suspends sending a scheduling request (SR);
UE MAC layer suspends increasing the beam failure indication (BFI) counter and/or starting the beam failure detection timer;
The parameter beamFailureInstanceMaxCount is set to a larger value, e.g., infinity; and
When UE assesses link quality, the UE may use the threshold (Q_{out,LR}+Q_{out_offset}) and/or (Q_{in,LR}+Q_{in_offset}), the offset value may be configured by the gNB and may be applicable only during the probing phase (e.g., within probing time window). Similarly, offset values may be added to the parameters Qᵢₙ and Qₒᵤₜ.

Other than the CSI, the UE may feedback one or more additional quantities:
Power headroom (tolerance) for beam failure event. For example, reference signal received power (RSRP)−Q_{out,LR} and/or RSRP −Q_{in_LR};
Power headroom (tolerance) for radio link failure event. For example, RSRP −Qₒᵤₜ and/or RSRP −Qᵢₙ; and
RSRP/SINR measured in probing phase −RSRP/SINR measured before the probing phase (e.g., the last values of RSRP/SINR before the probing phase).

In some embodiments, using the collected feedback, the UEs may be classified at least based on whether the UEs can continue normal operation when the gNB is in the energy saving state. For example, a first group of UEs may be in a cell-center and may maintain acceptable performance with a certain number of TXRUs turned off. A second group of UEs may be on a cell-edge and may maintain acceptable performance if some enhancements are applied, for example, coverage enhancements when a certain number of TXRUs are turned off. A third group of UEs may not have acceptable performance when a certain number of TXRUs are turned off, even if enhancements are applied. Different classifications may be applicable with different levels of the energy saving state.

In some embodiments, when the gNB enters an energy saving state, the behavior of the UEs may be determined by which group they are in. A UE may be assigned a group ID. Based on the group ID, the UE may adjust its behavior when the gNB is in the energy saving state. For example, a UE may be in group 3 and go to sleep mode when the gNB is in the energy saving state. In another example, the gNB may send a go-to-sleep signal before the gNB enters the energy saving state and indicates to one or a plurality of UEs to go to sleep. The go-to-sleep signal may be monitored by UEs belong to a specific group and/or configured with a specific tag/parameter. The go-to-sleep signal may be PDCCH based, where one bit in the PDCCH may indicate to a set of UEs whether to go to sleep or not.

In some embodiments, a UE may be indicated and/or configured to apply coverage enhancement techniques when the gNB is in the energy saving state. For example, one or a plurality of PDCCH, physical downlink shared channel (PDSCH), physical uplink shared channel (PUSCH), physical uplink control channel (PUCCH) may be subject to repetitions depending on the energy saving state of the gNB. The activation/deactivation of the coverage enhancement techniques may be determined by the energy saving state of the gNB.

In some embodiments, the gNB may be in different energy saving states depending on a particular time. For example, in certain slots the gNB may be in the normal state, while in some slots the gNB may be in the energy saving state. The gNB may send an indication of the energy saving state to the UEs. For example, a UE common PDCCH may be used for the indication. The UEs may be configured with a search space to monitor the PDCCH. One or more bits in the downlink control information (DCI) may indicate the energy saving state for a fixed amount of time. For example, if the time duration is N slots, then bits [1 1 0 0 1] may indicate that the gNB will be in power saving state (bit 1) during the first, second, and fifth periods of N slots; and the gNB will be in normal state (bit 0) during the third and fourth periods of N slots. By allocating more bits per duration, more than two states may be indicated. In another example, the UE may monitor the PDCCH according to a search space. The DCI in the PDCCH may indicate the energy saving state(s) and corresponding duration(s).

The embodiments for indicating the probing phase may be used to indicate the energy saving state. For example, the energy saving phase may occur periodically and a window similar to “probing window” may be defined as the time interval in which the gNB is in the energy saving phase. As another example, similar to the DRX ON period definition, certain slots may be denoted as belonging to the normal state (e.g., TXRUs are not turned off in those slots), and the remaining slots may be denoted as being to energy saving state. In some embodiments, the energy saving state may be activated with aperiodic signaling using PDCCH and/or MAC CE as disclosed for the probing phase.

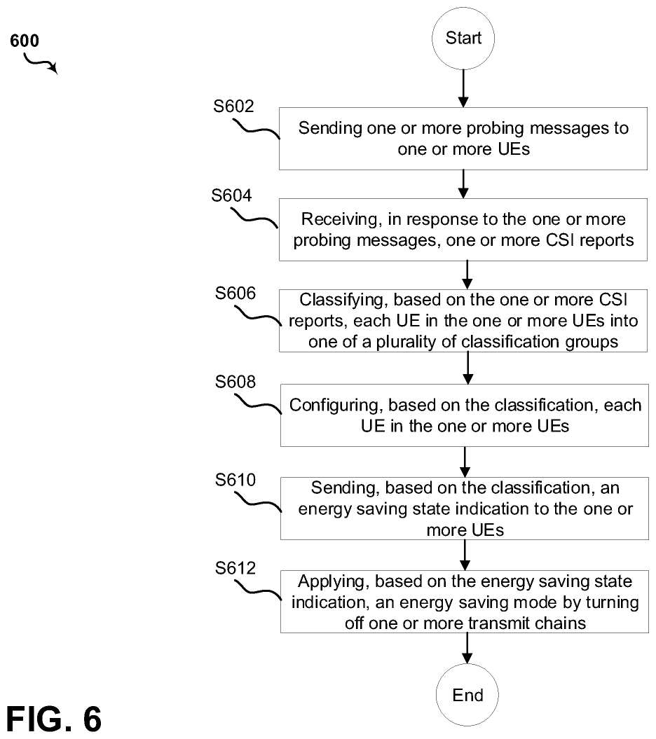

FIG. 6 illustrates a flowchart of an embodiment of a process 600 for performing network energy saving. The process 600 may be performed by a gNB. The process 600 may start at operation S602 where the gNB sends one or more probing messages to one or more UEs. The probing messages may include reference signals such as CSI reference signals.

The process proceeds to operation S604 where the gNB receives, in response to the one or more probing messages, one or more CSI reports. The process proceeds to operation S606 where, based on the one or more CSI reports, each UE is classified into one of a plurality of classification groups. For example, the classification groups may include groups 1-3 discussed above. The process proceeds to operation S608 where based on the classification, the UEs are configured. For example, the UEs may be configured for type 1 or type 2 reference signals as discussed above. The process proceeds to operation S610 where based on the classification, the gNB sends an energy saving state indication to the UEs. For example, the gNB may send a bit pattern (e.g., 1101) to indicate which slot the gNB will be in the energy saving state. The process proceeds to operation S612 where based on the energy saving state indication, the gNB applies an energy saving mode by turning off one or more transmit chains.

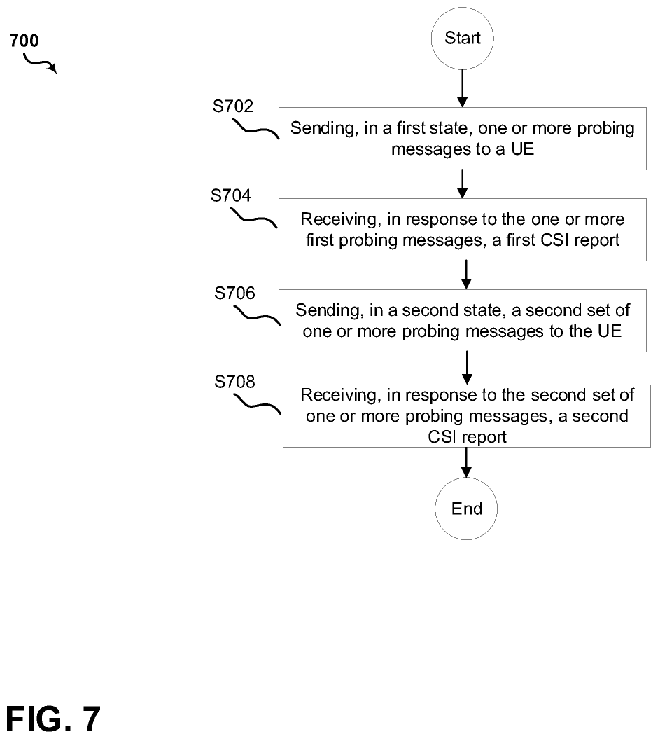

FIG. 7 illustrates a flowchart of an embodiment of a process 700 for probing UEs. The process 700 may start at operation S702 where a base station sends, in a first state, one or more probing messages to a UE. For example, the base station may be in a normal state where each antenna of the base station is turned on. The first set of the one or more probing messages may include a set of reference signals (e.g. 64 beams). The process proceeds to operation S704 where the base station receives, in response to the one or more first probing messages, a first CSI report. For example, the first CSI report may provide a first CSI corresponding to a measurement of the set of reference signals (e.g., 64 beams).

The process proceeds to operation S706 where the base station sends, in a second state, a second set of one or more probing messages to the UE. As an example, the second state may be an energy saving state where the base station turns off one or more antennas. The second set of one or more probing messages may include a subset of the reference signals (e.g., 8 beams). An indication may be provided to the UE indicating a timing of when the base station will enter the energy saving state. The process proceeds to operation S708 where the base station receives, in response to the second set of the one or more probing messages, a second CSI report. The second CSI report may include a second CSI based on a measurement of the subset of reference signals (e.g., 8 beams). Accordingly, the second CSI report may provide a CSI corresponding to the network energy saving state.

The foregoing disclosure provides illustration and description, but is not intended to be exhaustive or to limit the implementations to the precise form disclosed. Modifications and variations are possible in light of the above disclosure or may be acquired from practice of the implementations.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

The above disclosure also encompasses the embodiments listed below:

(1) A method performed by at least one processor of a base station, the method including: sending, in a first state, a first set of one or more probing messages to a UE, the first set of the one or more probing messages including a set of reference signals; receiving, in response to the first one or more probing messages, a first channel state information (CSI) report from the UEs that includes first CSI derived from measurements of the set of reference signals; sending, in a second state, a second set of one or more probing messages to the UE, the second set of the one or more probing messages including a subset of the reference signals; and receiving, in response to the second set of one or more probing messages, a second CSI report that includes second CSI derived from measurement of the subset of the reference signals.

(2) The method according to feature (1), in which the first state is a normal state and the second state is an energy saving state.

(3) The method according to feature (2), in which in the energy saving state, the base station turns off one or more antennas.

(4) The method according to any one of features (1)-(3), in which the first set of the one or more probing messages include an indication of a window having a duration in which the UE measures the subset of reference signals.

(5) The method according to feature (4), in which the base station configures the window with a periodic time interval.

(6) The method according to feature (4) or (5), in which the second CSI report is transmitted from the UE to the base station at a timing outside of the window. (7) The method according to any one of features (2)-(6), further including: transmitting, to the UE, a predetermined downlink signal that causes the UE to terminate measuring of the set of reference signals in the normal energy state and initiate measuring of the subset of reference signals in the energy saving state.

(8) The method according to feature (7), in which the predetermined downlink signal is a physical downlink control channel (PDCCH) signal.

(9) The method according to feature (7) o (8), in which the measuring of the subset of reference signals is terminated after a predetermined time interval.

(10) The method according to any one of features (1)-(9), further including classifying, based on the one or more CSI reports, each UE in the one or more UEs into one of a plurality of classification groups.

(11) The method according to feature (10), in which the plurality of classification groups include: (i) a first classification group in which each UE assigned to the first classification group does not utilize cell enhancement coverage when the base station is in the energy saving state, and (ii) a second classification group in which each UE assigned to the second classification group utilizes cell enhancement coverage when the base station is in the energy saving state.

(12) The method according to feature (11), in which the cell enhancement coverage includes repetition of one or more downlink signals or repetition of one or more uplink signals.

(13) The method according to feature (12), in which the one or more downlink signals include one of a physical downlink control channel (PDCCH) signal and a physical downlink shared channel (PDSCH) signal, and in which the one or more uplink signals include one of a physical uplink shared channel (PUSCH) and a physical uplink control channel (PUCCH) signal.

(14) The method according to any one of features (2)-(13), further including: transmitting to the UE an, energy saving state indication that includes one or more bits specifying one or more time slots in which the energy saving state is applied.

(15) An apparatus including: at least one memory configured to store computer program code; and at least one processor configured to access said at least one memory and operate as instructed by the computer program code, the computer program code including: first sending code configured to cause at least one of said at least one processor to send, in a first state, a first set of one or more probing messages to a UE, the first set of the one or more probing messages including a set of reference signals; first receiving code configured to cause at least one of said at least one processor to receive, in response to the first one or more probing messages, a first channel state information (CSI) report from the UEs that includes first CSI derived from measurements of the set of reference signals; second sending code configured to cause at least one of said at least one processor to send, in a second state, a second set of one or more probing messages to the UE, the second set of the one or more probing messages including a subset of the reference signals; and second receiving, in response to the second set of one or more probing messages, a second CSI report that includes second CSI derived from measurement of the subset of the reference signals.

(16) The apparatus according to feature (15), in which the first state is a normal state and the second state is an energy saving state.

(17) The apparatus according to feature (16), in which in the energy saving state, the base station turns off one or more antennas.

(18) The apparatus according to any one features (15)-(17), in which the first set of the one or more probing messages include an indication of a window having a duration in which the UE measures the subset of reference signals.

(19) The apparatus according to feature (18), in which the base station configures the window with a periodic time interval.

(20) A non-transitory computer readable medium having instructions stored therein, which when executed by a processor in a base station cause the processor to execute a method including: sending, in a first state, a first set of one or more probing messages to a UE, the first set of the one or more probing messages including a set of reference signals; receiving, in response to the first one or more probing messages, a first channel state information (CSI) report from the UEs that includes first CSI derived from measurements of the set of reference signals; sending, in a second state, a second set of one or more probing messages to the UE, the second set of the one or more probing messages including a subset of the reference signals; and receiving, in response to the second set of one or more probing messages, a second CSI report that includes second CSI derived from measurement of the subset of the reference signals.

What is claimed is:

1. A method performed by at least one processor of a base station, the method comprising:
sending, in a first state, a first set of one or more probing messages to a UE, the first set of the one or more probing messages including a set of reference signals;
receiving, in response to the first one or more probing messages, a first channel state information (CSI) report from the UEs that includes first CSI derived from measurements of the set of reference signals;
sending, in a second state, a second set of one or more probing messages to the UE, the second set of the one or more probing messages including a subset of the reference signals; and
receiving, in response to the second set of one or more probing messages, a second CSI report that includes second CSI derived from measurement of the subset of the reference signals.

2. The method according to claim 1, wherein the first state is a normal state and the second state is an energy saving state.

3. The method according to claim 2, wherein in the energy saving state, the base station turns off one or more antennas.

4. The method according to claim 1, wherein the first set of the one or more probing messages include an indication of a window having a duration in which the UE measures the subset of reference signals.

5. The method according to claim 4, wherein the base station configures the window with a periodic time interval.

6. The method according to claim 4, wherein the second CSI report is transmitted from the UE to the base station at a timing outside of the window.

7. The method according to claim 2, further comprising:
transmitting, to the UE, a predetermined downlink signal that causes the UE to terminate measuring of the set of reference signals in the normal energy state and initiate measuring of the subset of reference signals in the energy saving state.

8. The method according to claim 7, wherein the predetermined downlink signal is a physical downlink control channel (PDCCH) signal.

9. The method according to claim 7, wherein the measuring of the subset of reference signals is terminated after a predetermined time interval.

10. The method according to claim 1, further comprising classifying, based on the one or more CSI reports, each UE in the one or more UEs into one of a plurality of classification groups.

11. The method according to claim 10, wherein the plurality of classification groups include: (i) a first classification group in which each UE assigned to the first classification group does not utilize cell enhancement coverage when the base station is in the energy saving state, and (ii) a second classification group in which each UE assigned to the second classification group utilizes cell enhancement coverage when the base station is in the energy saving state.

12. The method according to claim 11, wherein the cell enhancement coverage includes repetition of one or more downlink signals or repetition of one or more uplink signals.

13. The method according to claim 12, wherein the one or more downlink signals include one of a physical downlink control channel (PDCCH) signal and a physical downlink shared channel (PDSCH) signal, and wherein the one or more uplink signals include one of a physical uplink shared channel (PUSCH) and a physical uplink control channel (PUCCH) signal.

14. The method according to claim 2, further comprising:
transmitting to the UE an, energy saving state indication that includes one or more bits specifying one or more time slots in which the energy saving state is applied.

15. An apparatus comprising:
at least one memory configured to store computer program code; and
at least one processor configured to access said at least one memory and operate as instructed by the computer program code, the computer program code including:
first sending code configured to cause at least one of said at least one processor to send, in a first state, a first set of one or more probing messages to a UE, the first set of the one or more probing messages including a set of reference signals;
first receiving code configured to cause at least one of said at least one processor to receive, in response to the first one or more probing messages, a first channel state information (CSI) report from the UEs that includes first CSI derived from measurements of the set of reference signals;
second sending code configured to cause at least one of said at least one processor to send, in a second state, a second set of one or more probing messages to the UE, the second set of the one or more probing messages including a subset of the reference signals; and
second receiving, in response to the second set of one or more probing messages, a second CSI report that includes second CSI derived from measurement of the subset of the reference signals.

16. The apparatus according to claim 15, wherein the first state is a normal state and the second state is an energy saving state.

17. The apparatus according to claim 16, wherein in the energy saving state, the base station turns off one or more antennas.

18. The apparatus according to claim 15, wherein the first set of the one or more probing messages include an indication of a window having a duration in which the UE measures the subset of reference signals.

19. The apparatus according to claim 18, wherein the base station configures the window with a periodic time interval.

20. A non-transitory computer readable medium having instructions stored therein, which when executed by a processor in a base station cause the processor to execute a method comprising:
sending, in a first state, a first set of one or more probing messages to a UE, the first set of the one or more probing messages including a set of reference signals;
receiving, in response to the first one or more probing messages, a first channel state information (CSI) report from the UEs that includes first CSI derived from measurements of the set of reference signals;
sending, in a second state, a second set of one or more probing messages to the UE, the second set of the one or more probing messages including a subset of the reference signals; and
receiving, in response to the second set of one or more probing messages, a second CSI report that includes second CSI derived from measurement of the subset of the reference signals.
